(19) United States
(12) Patent Application Publication
(10) Pub. No.: US 2025/0120345 A1
(43) Pub. Date: Apr. 17, 2025

(54) DEVICE FOR GERMINATING, GROWING AND/OR PROPAGATING PLANTS

(71) Applicant: Eric BAUDOUIN, COADOUT (FR)

(72) Inventor: Eric BAUDOUIN, COADOUT (FR)

(21) Appl. No.: 18/701,445

(22) PCT Filed: Oct. 13, 2022
(86) PCT No.: PCT/FR2022/051929

§ 371 Date: Apr. 15, 2024

(30) Foreign Application Priority Data
Oct. 13, 2021 (FR) FR2110864

(51) Int. Cl. A01G 9/02

(52) U.S. Cl. CPC A01G 9/028; A01G 9/0302

(57) ABSTRACT

A device for germinating, growing and/or propagating one or more plants, has at least two dividers and at least two combs which allow the dividers to be arranged so as to create at least one space for germinating, growing and/or propagating one or more plants. The dividers each have a corrugated shape, as do the combs.

The invention relates to a device for germinating, growing and/or propagating plants, comprising dividers and combs for organizing these dividers, to its implementation method, and to the various constituent elements of this device, such as the combs.

### INTRODUCTION

The cultivation of plants entails controlling their germination and/or their propagation. It is also an activity which is sensitive to the season and the climate conditions.

Cultivation in trays is therefore common to assist in controlling the cultivation of plants, whether privately or professionally.

Thus, U.S. Pat. No. 4,578,899 (A) relates to a set of growing cells for the cultivation of plants, comprising several rows of pots parallel to one another. Each of the rows of pots adjoining one another has a common wall construction partly decomposing during the growing of the plants, said wall construction consisting of three material layers laminated together. After the stage of growing of the plants, at least partial decomposition of the cells makes it possible to release the plants.

However, there are several drawbacks with this type of device. On the one hand, the degradation must be suitable for the one or more types of plants cultivated. On the other hand, the device cannot be customized easily and cannot be dismounted for possible reuse.

FR962699A relates to a seedbox consisting of a set of lateral walls that are joined to one another and secured both to feet, allowing superposition, and aeration, of multiple boxes so as to reduce the size thereof and make it easier to transport them, and to means intended to support a removable base.

EP0012013 discloses a planting tray similar to that described in FR962699A with a non-perforated base.

DE115528 discloses a planting tray similar to those described in FR962699A and EP0012013 in an internal enclosure.

GB2380115 discloses a planting container similar to those described in FR962699A, EP0012013 and DE115528 on a tray.

Similarly, FR2382180 relates to a rooting device used for the continuous cultivation of plants in bulk. The containers have a shape such that the plants can grow and take root in individual containers. A grating is divided into grating cells with cross sections having non-bent sides. Specifically, the device is rectangular and has a frame, which consists of wooden joists.

However, implementing the cultivation of the plants is awkward with these types of devices (i.e. those described in FR962699A, EP0012013, DE115528, GB2380115 and FR2382180) for several reasons. For example, the removal of the plug from each plant germinating, growing and/or propagating cell is not optimized if the device does not comprise a stiffening element (such as an outer box or a tray): for dismounting of the device, the withdrawal of the walls or joists affects the cohesion of the seedbox assembly. Thus, management at least “row by row”, particularly in a random order depending on the results of the germination/growth, during the removal of the plug is desirable. Moreover, mounting the seedbox is difficult, since its cohesion is provided by the set of walls once they are all interlocked.

U.S. Pat. No. 4,453,344 (A) relates to a seed cultivation container in which a certain number of removable partitions or barriers are positioned together in a box. Each of the partitions has interconnected diverging walls forming a series of troughs therebetween, which are open at the top and the bottom so as to form growing compartments suitable for growing a single seedling each. The partitions have a corrugated shape, and so there is no need for an orthogonal mesh in order to generate compartments.

U.S. Pat. No. 6,401,387 (A) discloses a planting tray similar to those described in U.S. Pat. No. 4,453,344 (A) with a drain board (mounted in a watertight box) on which the troughs are positioned.

Moreover, U.S. Pat. No. 4,777,764 discloses a plurality of partitions, each with a sinusoidal overall shape, which are connected to one another by a bridging wall comprising respective opposite fixing means for removably joining said partitions. However, on the one hand this type of device does not make it possible to withdraw a single row randomly, given that it is necessary to slide all the previous rows, and the stiffness of the assembly is compromised because it is not maintained by the bridging wall. On the other hand, a significant volume is needed to store the various elements when not in use.

GB493730 (A) discloses “seedling receptacles” also made up of similar “corrugated rigid strips” that are placed in juxtaposition but, by contrast to U.S. Pat. Nos. 4,453,344 (A) and 6,401,387 (A), are not comprised in a box and are simply placed in juxtaposition but unconnected.

However, in the best case, the spacers (or “corrugated rigid strips”) are held together by the very enclosure that contains them (U.S. Pat. Nos. 4,453,344 (A) and 6,401,387 (A)) or even not held at all. This type of device is not easy to implement: when being mounted (in the case of U.S. Pat. Nos. 4,453,344 (A) and 6,401,387 (A)), the spacers are not held, and in the case of GB493730 (A), the corrugated rigid strips are supposed to be directly implanted in the soil.

There is therefore a lack in the art of a plant germinating, growing and/or propagating means in which the plants are isolated from one another which is practical, effective and easy to store when not in use.

The aim of the invention is therefore to overcome the drawbacks of the prior art.

### SUMMARY OF THE INVENTION

For this, the invention thus relates, in its broadest sense, to a device for germinating, growing and/or propagating one or more plants, comprising at least two dividers and at least two combs for arranging the dividers so as to create at least one volume for germinating, growing and/or propagating one or more plants, characterized in that the dividers each have a corrugated shape.

One of the advantages of the device according to the invention is to be able to easily mount it by interlocking the dividers and the combs.

Moreover, when more than 2 combs are present (such as two combs on the opposite sides, and another comb in between, for example, in the center), inserting dividers of different lengths makes it possible to customize the germinating, growing and/or propagating volumes depending on the nature of the plants or their states of development.

The various elements of the device for germinating, growing and/or propagating one or more plants according to the present invention are also very easy to store given the small volume necessary for stowing them away. This is because the various elements can be stacked on one another (or alongside one another) when they are not implemented to create volumes for germinating, growing and/or propagating one or more plants in the device according to the present invention.

In addition, the invention thus relates to a comb for implementing the device for germinating, growing and/or propagating one or more plants, comprising at least two dividers and at least two combs for arranging the dividers so as to create at least one volume for germinating, growing and/or propagating one or more plants, wherein the dividers each have a corrugated shape, said comb being made up of teeth and slits, characterized in that at least two slits are disposed on different sides of the comb.

Further features of the invention are described below.

The device for germinating, growing and/or propagating one or more plants, comprising at least two dividers and at least two combs for arranging the dividers so as to create at least one volume for germinating, growing and/or propagating one or more plants, wherein the dividers each have a corrugated shape, can moreover be characterized in that:
the combs are made up of teeth and slits,
at least one of the combs is formed by an independent bar passing through all the dividers, said bar comprising, at least at one of its ends (the bar thus comprising two ends), a reversible fixing means, such as a thread for a nut and/or a screw, and/or a system of clips for holding the dividers in place;
at least two of the combs are each formed by an independent bar passing through all the dividers, said bars comprising, at least at one of their ends (the bars thus comprising two ends), a reversible fixing means, such as a thread for a nut and/or a screw, and/or a system of clips for holding the dividers in place;
the combs may be placed at the ends of the dividers;
the combs and the dividers can be removably fixed to one another, making said device dismountable;
the combs may be placed at the ends of the dividers and the combs and the dividers are removably fixed to one another, making said device dismountable;
it is possible for said device to not have a base directly adjoining the volumes defined by the dividers. One of the advantages of the device according to the present invention is that it does not comprise a base, thereby enabling better growth of the roots. As a result, it is possible to transfer the plants by simply removing the plugs without damaging the roots. This has been noted more particularly in devices according to the present invention having a comb and divider height of less than or equal to 5 cm;
the dividers can come into contact with one another at least once each;
the at least two dividers may have the same corrugated shape, advantageously offset or reversed so as to create a cellular structure;
the arrangement of the dividers may form a cellular structure, for example in the form of a honeycomb;
said device may comprise between 3 and 10 dividers;
the corrugated shape may comprise a partial polygonal repeating pattern, such as a partial repeating pattern of a triangle, a square, a hexagon, an octagon, a decagon or a dodecagon;
the dividers and combs may be rigid;
the dividers and combs may be made independently from one another from at least one natural, bio-sourced, synthetic, biodegradable, mineral, organic, polymer and/or petroleum-based material;
the dividers and/or the combs may be made from the same material;
the dividers and/or the combs may be made of a polymer material, such as plastic or cellulose, a natural material, such as wood, a bio-sourced material and/or a biodegradable material, such as PLA;
the dividers and combs may be made from the same material, preferably a polymer material, such as plastic, a natural material, such as wood, or a bio-sourced and advantageously biodegradable material, such as PLA;
the dividers may each comprise at least one opening for the passage of a bar through the dividers;
the corrugated dividers may be straight dividers with a sinusoidal shape; and/or
the dividers may be juxtaposed alongside one another to form a cellular structure.

As regards the comb for implementing the device for germinating, growing and/or propagating plants, comprising at least two dividers and at least two combs for arranging the dividers so as to create at least one germinating, growing and/or propagating volume, wherein the dividers each have a corrugated shape, said comb is made up of teeth and slits, characterized in that:
said at least two slits are disposed on different sides of the comb;
said at least two slits are disposed on opposite sides of the comb;
the width of the slits is smaller in size than the width of the teeth; or
said at least two slits are disposed on opposite sides of the comb and width of the slits is smaller in size than the width of the teeth.

In a particular embodiment, said dividers comprise two openings passing all the way through these dividers and said combs are rigid bars designed to be inserted into the openings in the dividers. Said bars each comprise, at least at one of their ends, a reversible fixing means, such as a thread for a nut and/or a screw for holding the dividers in place. In this embodiment, the openings in the dividers are placed such that they are in line with one another and therefore the dividers form germinating, growing and/or propagating volumes between the dividers when the bars are inserted in said openings.

Particularly, when the combs are bars, they may have a circular, oval, polygonal, such as triangular, rectangular, square, rhomboid, pentagonal, hexagonal, etc. cross section.

### DEFINITIONS

In the context of the present invention, a “device for germinating, growing and/or propagating plants” is understood to mean a device comprising at least one enclosure in which a plant seed can be inserted and left to germinate and/or grow. As an alternative, or in combination, this device may make it possible to propagate at least one plant.

In the context of the present invention, a “dismountable device” is understood to mean that the device is made up of various elements that can be separated from one another and thus dismounted.

In the context of the present invention, “dividers” are understood to mean walls for delimiting one or more troughs in which a plant seed or a plant and a growth sutotrate (such as soil) can be inserted. The dividers are defined by a length, height and thickness. In terms of size, the length of a divider is greater than its height, which is greater than its thickness.

In the context of the present invention, “combs” are understood to mean a strip or a bar which is rigid enough to hold the dividers. Reference is made to the term “comb” in the context of the present invention since, in the case of a strip, it comprises notches or slits which give it the appearance of a comb. Still, the function of “combs” according to the present invention is to provide an even spacing between the dividers, to hold them at their ends and to stiffen the assembly without the addition of a base with rims. The dividers may have one or more openings for inserting one or more combs in the form of a bar. Advantageously, the combs are in the form of a strip. The combs in the form of a strip are defined by a length, height and thickness. Thus, in the context of the present invention, “different sides of the comb” are the different sides of the geometric shape (polygon such as a rectangle) that are formed by the projection, into one and the same plane, of the length and the height of the comb (i.e. the thickness is not taken into consideration).

In the context of the present invention, a notch is not considered to be an opening, and vice versa; a notch is an indentation, that is to say a cutout, a recessed or set-back part on the edge of the part in question (for example a comb or a divider). An opening, by contrast, is placed in a portion of the part such that said opening does not form an indentation.

In the context of the present invention, a “volume for germinating, growing and/or propagating” one or more plants is understood to mean an enclosure delimited by walls (via the dividers) in which one or more plant seeds or one or more plants and a growth medium (such as soil) can be inserted.

In the context of the present invention, a “corrugated shape” is understood to mean that the dividers are corrugated when viewed on their thickness side. A corrugation has a zigzag shape. In the context of the present invention, the term “corrugated” is distinguished from the term “sinusoidal” in that “corrugated” has a broader meaning (or scope). Indeed, a corrugated shape may include salient angles so as to form polygonal patterns, whereas, in the context of the present invention, a sinusoidal shape comprises specifically rounded shapes (that is to say without salient angles or significant—i.e. visible-straight-line portions). In the context of the present invention, the expression “straight dividers with a sinusoidal shape” is understood to mean that the divider has a sinusoidal shape along a straight line. In the context of the present invention, polygons with rounded corners will thus also be considered to constitute corrugations.

In the context of the present invention, “the implementation of the device” is understood to mean an assembly of the various parts making up a device according to the present invention, resulting in a shape of the device which enables the germination and/or propagation of plants.

In the context of the present invention, “slits” are understood to mean notches in the comb for inserting a portion of the dividers according to the invention.

In the context of the present invention, a “tooth” is understood to mean the solid part of the comb comprised between two slits.

### FIGURES

Embodiments of the present invention shall be described hereinafter by way of nonlimiting examples, with reference to the appended figures in which:

FIG. 1 depicts a divider with a corrugated shape;

FIG. 2 is a top view of the device for germinating, growing and/or propagating one or more plants according to the present invention;

FIG. 3 is a 3-dimensional view of the device for germinating, growing and/or propagating one or more plants according to the present invention, placed on a tray;

FIG. 4 is embodiments taken from GB493730 showing examples of corrugations that can be applied to the dividers 1 according to the present invention;

FIG. 5 is a top view of the device for germinating, growing and/or propagating one or more plants according to the present invention, wherein the comb is a threaded bar;

FIG. 6 is a 3-dimensional view of the device for germinating, growing and/or propagating one or more plants according to the present invention, wherein the comb is a threaded bar.

In all of the figures depicted, the same element reference numbers have been used from one figure to the next.

### DETAILED DESCRIPTION

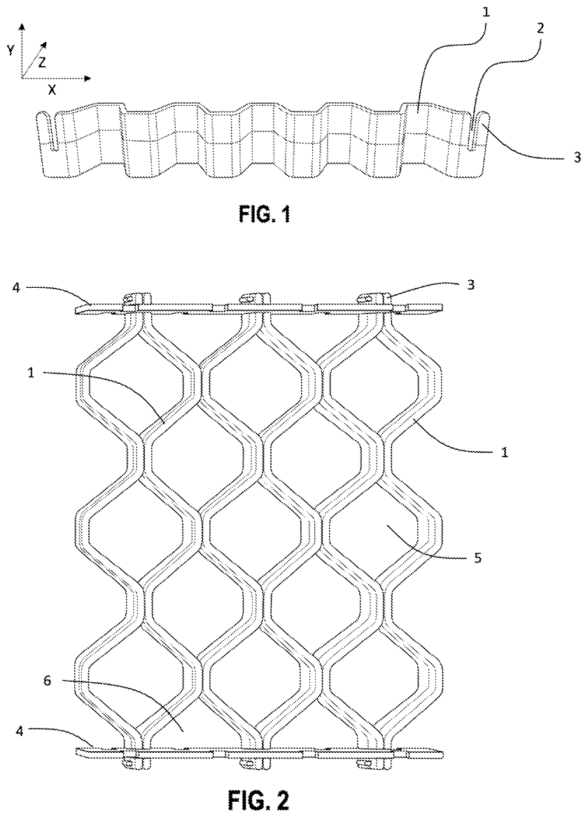

The divider 1 in FIG. 1 represents an element of a particular embodiment of the present invention, wherein the corrugated shape comprises a partial hexagonal repeating pattern. By convention, the length of the divider 1 coincides with the X axis, the width of the divider 1 coincides with the Y axis and the thickness of the divider 1 is defined along the Z axis. It should be noted that, in this depiction, since the corrugation is made along the Z axis, the thickness varies along that axis. The divider in FIG. 1 makes it possible to define four full germinating, growing and/or propagating volumes on the visible face (or front face in the figure) of the divider and five full germinating, growing and/or propagating volumes on the concealed face (or rear face in the figure, i.e. in the continuation of the Z axis).

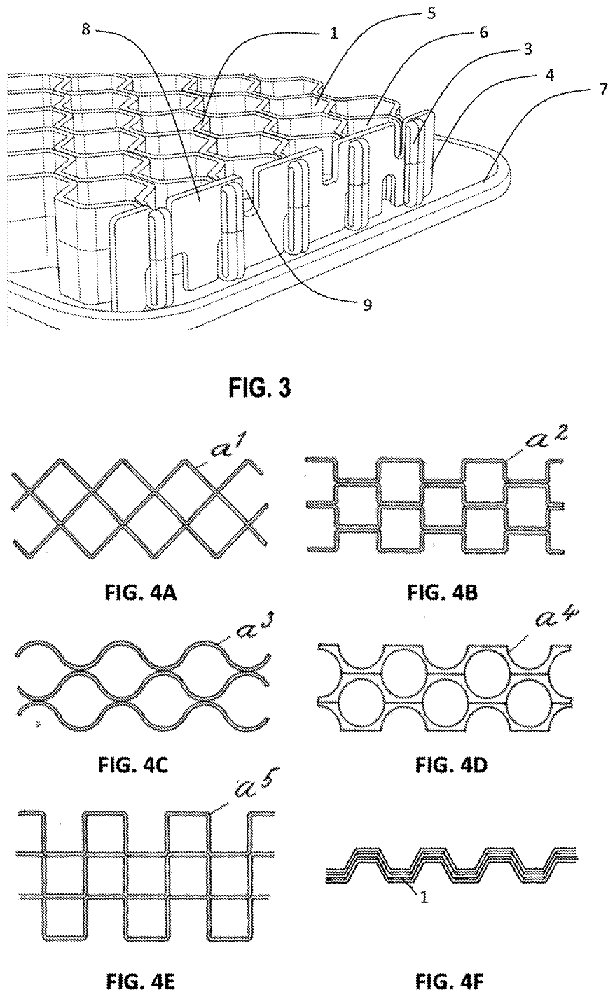

A notch 2 makes it possible to delimit an end protuberance 3. The combination of notch 2 and protuberance 3 makes it possible to fix the divider 1 to the comb 4 by interlocking, as shown in FIGS. 2 and 3.

FIG. 2 shows a device for germinating, growing and/or propagating one or more plants according to the invention utilizing dividers 1 defining three and two full volumes 5 for germinating, growing and/or propagating one or more plants on each side of each divider 1. It can also be noted that the half-volumes 6 for germinating, growing and/or propagating one or more plants are in contact with the combs 4. The shape of the volumes for germinating, growing and/or propagating one or more plants is hexagonal or half-hexagonal (at the edge of the combs 4). The dividers are coupled with one another and interlocked in the combs 4.

In general, the dividers 1 can be interlocked with the combs 4 in pairs.

FIG. 3 shows a 3D view of a device according to the present invention comprising 10 dividers interlocked in pairs in at least one comb 4. The teeth 8 and the slits 9 of the comb can be seen. A tray 7 supports the device according to the present invention. This tray is not fixed to the device according to the present invention in this embodiment.

The dimensions of the combs and the dividers may be adapted to the plants that are to be cultivated.

In particular, combs and dividers may have any suitable height.

For example, the height of the combs and the dividers may be comprised between 1 cm and 1 meter. With preference, the height of the combs and/or the dividers is comprised between 1.5 cm and 50 cm, such as comprised between 2 cm and 25 cm, comprised between 2.5 cm and 20 cm, comprised between 3 cm and 15 cm, comprised between 3.5 cm and 10 cm, comprised between 4 cm and 8 cm or comprised between 4.5 cm and 6 cm, such as 5 cm plus or minus 0.2 cm.

For example, the height of the combs and the dividers may be less than or equal to 1 meter, less than or equal to 50 cm, less than or equal to 25 cm, less than or equal to 20 cm, less than or equal to 15 cm, less than or equal to 10 cm, less than or equal to 8 cm, less than or equal to 7 cm, less than or equal to 6 cm, less than or equal to 5 cm, less than or equal to 4.5 cm, less than or equal to 4 cm, less than or equal to 3.5 cm, less than or equal to 3 cm, less than or equal to 2.5 cm, less than or equal to 2 cm, less than or equal to 1.5 cm or less than or equal to 1 cm.

With preference, the height of the combs and/or the dividers is 4.8 cm plus or minus 0.2 cm, 3.8 cm plus or minus 0.2 cm, 2.5 cm plus or minus 0.2 cm, 2.2 cm plus or minus 0.2 cm.

In a particular embodiment, the height of the combs and the dividers is not the same.

To illustrate the adaptation of the height of the combs and the dividers, this can be done depending on the size of the seeds, and/or the size of the plant.

For example, the height of the combs and the dividers for germinating a sunflower seed (fairly large seed) may be 5 cm.

For example, the height of the combs and the dividers for growing and propagating a walnut tree (bulky plant) may be 50 cm, and it is possible for it to comprise only a single plant germinating, growing and/or propagating volume.

For example, the height of the combs and the dividers for germinating radish (small seed) may be 2.2 cm.

For example, the height of the combs and the dividers for germinating a tomato seed (small seed) may be 2.2 cm.

For example, the height of the combs and the dividers for growing a tomato plant may be approximately 5 to 25 cm.

Any cultivation substrate, whether solid, liquid or gel, can be used with the device according to the present invention. In the case of a liquid substrate, the device according to the present invention is preferably placed in a container. Such a substrate may be soil, earth, a hydroponic medium, a nutrient-containing gel, etc.

In one embodiment, the one or more germinating, growing and/or propagating volumes are completely filled with cultivation substrate.

In one embodiment, the one or more germinating, growing and/or propagating volumes are partially filled with cultivation substrate, for example to an amount less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, or less than or equal to 30% of the one or more volumes in question.

In one embodiment, the color of the combs and the dividers is adapted to the nature of the plant that is to germinate, grow and/or propagate. For example, the combs and the dividers may be a dark color, such as black, or a light color, such as white.

This is because it has been noted that certain seedlings, such as tomato seedlings, grow better in devices according to the present invention that have a dark color, such as black.

By contrast, and more generally, plants (such as radish) grow better in devices according to the present invention that have a light color, such as white.

FIG. 4 is embodiments taken from GB493730 showing examples of corrugations that can be applied to the dividers 1 according to the present invention.

Thus, FIG. 4 (4A) depicts a V-shaped corrugation with salient angles (that is to say with a partial triangular shape), in which the dividers a¹ are juxtaposed against one another to create volumes for germinating, growing and/or propagating one or more plants.

FIG. 4 (4B) shows dividers a² in which the corrugations have right-angled U shapes (that is to say with a partial square shape), each forming one complete side and two half-sides of a volume for germinating, growing and/or propagating one or more plants.

In FIG. 4 (4C), the corrugated dividers a³ depicted have contours which are circular (that is to say of sinusoidal shape).

In FIG. 4 (4D), the corrugated dividers a⁴ are realized so as to press against one another by way of flat faces and form volumes for germinating, growing and/or propagating one or more plants that are mutually circular, so as to reconstruct volumes for germinating, growing and/or propagating one or more plants with a conventional, cylindrical flower-pot shape.

In FIG. 4 (4E), the dividers a⁵ are formed with corrugations having a right-angled T shape (that is to say with a partial square shape), but in this case each corrugation forms three complete sides of a volume for germinating, growing and/or propagating one or more plants.

FIG. 4 (4F) shows how, in some cases (in this instance, a partial hexagonal shape), the dividers 1 can be stacked with one another to reduce the volume when they are being transported or stored.

Shapes other than those illustrated here can be used to realize dividers 1 according to the present invention.

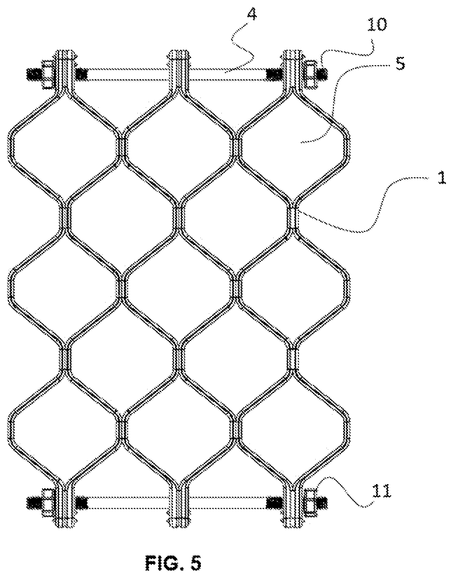

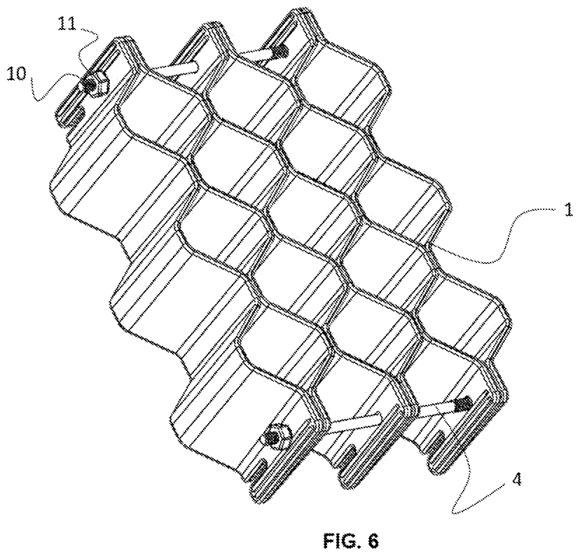

FIG. 5 shows a device for germinating, growing and/or propagating one or more plants according to the invention utilizing dividers 1 defining full volumes 5 for germinating, growing and/or propagating one or more plants on each side of each divider 1. In this instance, the combs 4 are tubular bars of circular cross section (hollow or solid tubular cylinder) provided at their ends with two threads 10 and with bolts 11 for holding the dividers 1. The shape of the volumes for germinating, growing and/or propagating one or more plants is hexagonal. The dividers are coupled with one another and thus held by the combs 4.

FIG. 6 shows a 3D view of a device according to the present invention comprising dividers 1 held by two combs 4 in the form of tubular bars of circular cross section (hollow or solid tubular cylinder) provided at their ends with two threads 10 and with bolts 11 for holding the dividers 1.

The lengths of the combs and the dimensions of the dividers in FIGS. 5 and 6 do not differ from those of the previous figures and can be adapted to the plants that are to be cultivated.

In particular, the dividers may have any suitable height.

For example, the height of the dividers may be comprised between 1 cm and 1 meter. With preference, the height of the dividers is comprised between 1.5 cm and 50 cm, such as comprised between 2 cm and 25 cm, comprised between 2.5 cm and 20 cm, comprised between 3 cm and 15 cm, comprised between 3.5 cm and 10 cm, comprised between 4 cm and 8 cm or comprised between 4.5 cm and 6 cm, such as 5 cm plus or minus 0.2 cm.

The length of the combs and/or the dividers can vary, for example between 3 cm and 5 meters, preferably between 20 cm and 2 meters, more preferably between 30 cm and 1 meter.

1. A device for germinating, growing and/or propagating one or more plants, comprising:
at least two dividers and at least two combs for arranging the dividers so as to create at least one volume for germinating, growing and/or propagating one or more plants, wherein the dividers each have a corrugated shape.

2. The device as claimed in claim 1, wherein the combs are placed at the ends of the dividers and in that the combs and the dividers are removably fixed to one another, making said device dismountable.

3. The device as claimed in claim 1, wherein said device does not have a base directly adjoining the volumes defined by the dividers.

4. The device as claimed in claim 1, wherein the arrangement of the dividers forms a cellular structure, for example in the form of a honeycomb.

5. The device as claimed in claim 1, wherein the corrugated shape comprises a partial polygonal repeating pattern, such as a partial repeating pattern of a triangle, a square, a hexagon, an octagon, a decagon or a dodecagon.

6. The device as claimed in claim 1, wherein the dividers and/or the combs are made from the same material.

7. The device as claimed in claim, wherein the dividers and combs are made of a polymer material, such as plastic or cellulose, a natural material, such as wood, a bio-sourced material and/or a biodegradable material, such as PLA.

8. The device as claimed in claim 1, wherein the corrugated dividers are straight dividers with a sinusoidal shape.

9. A comb (4) for implementing the device as claimed in claim 1, said comb being made up of teeth and slits, wherein at least two slits are disposed on different sides of the comb.

10. The comb as claimed in claim 9, wherein said at least two slits are disposed on opposite sides of the comb and in that the width of the slits is smaller in size than the width of the teeth.
